(19) United States
(12) Patent Application Publication
(10) Pub. No.: US 2006/0120006 A1
(43) Pub. Date: Jun. 8, 2006

(54) Apparatus and method for transmitting of energy and/or data between a source and a receiver movable relative thereto

(76) Inventor: Bernhard Bennertz, Krefeld (DE)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/319,834

(22) Filed: Dec. 28, 2005

Related U.S. Application Data
(63) Continuation of application No. PCT/EP03/08071, filed on Jul. 23, 2003.

(51) Int. Cl. H01H 47/00

(52) U.S. Cl. 361/143

(57) ABSTRACT

An apparatus for transmitting energy and/or information between a source and a receiver movable relative to the source includes a first coil coupled to the source, a second coil coupled to the movable receiver and movable relative to the first coil, and means for transmitting a magnetic field generated by the first coil to the second coil for inducing a current in the second coil. Thereby, it is achieved that the receiver can be energized, without having to use a battery for this. Furthermore, information may thereby be transmitted from the source to the receiver. By taking out energy from the magnetic field and by modulation of the same induced thereby, information also may be transmitted from the receiver to the source.

### CROSS-REFERENCE TO RELATED APPLICATION

This application is a continuation of co-pending International Application No. PCT/EP03/08071, filed Jul. 23, 2003, which designated the United States and was not published in English and is incorporated herein by reference in its entirety.

### BACKGROUND OF THE INVENTION

1. Field of the Invention

The present invention relates to transmission of energy and/or information from a source to a receiver movable relative thereto, and vice versa.

2. Description of the Related Art

For energizing a consumer arranged in a movable system, for example, a battery arranged in the movable system may be used. In that, however, it is disadvantageous that a battery has finite life and may also have a relatively high weight.

If the movable consumer also is to transmit information to a stationary, i.e. motionless system, or an otherwise moved system, an additional communication link, e.g. a radio link, has to be built up between the movable consumer and the stationary or otherwise moved system. In this, it is disadvantageous that the communication link causes additional costs.

If the movable consumer is a tire pressure sensor, for example, the pressure measurement values have to be transmitted from the movable consumer arranged in a moved system to a system (vehicle) stationary with reference to the moved system (car tire). For transmitting the pressure measurement values, active transponders may be employed, which transmit a measurement value to a reception device (reading device) outside the tire via a radio link through a rubber-steel cover of the tire. This approach is used by commercially available systems for measuring internal pressure of a car tire. Besides the undesirable factors already mentioned, namely the finite battery life as well as its high weight, the active transponder communicates with the reading device via radio waves through the air, whereby an environment is polluted by alternating electromagnetic fields. Moreover, the radio waves may interfere with other electronic systems and lead to their malfunction. This is a fundamental disadvantage particularly in safety-relevant aspects, such as brake control. With increasing distance between the active transponder and the reading device, transmitting power is increased on the one hand in order to bridge the greater range, so that the alternating electromagnetic fields have an increasingly disturbing effect. Moreover, the life of the battery is thereby shortened, because the active transponder, which now has to transmit at higher transmitting power, has to draw it from the battery.

### SUMMARY OF THE INVENTION

It is an object of the present invention to provide an efficient concept for transmitting energy and/or information between a source and a receiver movable relative thereto.

In accordance with a first aspect, the present invention provides an apparatus for transmitting energy and information between a source and a receiver movable relative to the source, having: a first coil coupled to the source; a second coil coupled to the receiver and rotatable about a rotation axis relative to the first coil; and a magnetic field transmitter of magnetizable material for transmitting a magnetic field generated by the first coil to the second coil for inducing a current in the second coil; wherein the rotation axis of the rotatable second coil coincides with a longitudinal axis of the magnetic field transmitter, and wherein the magnetic field transmitter of magnetizable material extends through the first and second coils.

In accordance with a second aspect, the present invention provides a method of transmitting energy and information between a source coupled to a coil and a receiver movable relative to the source and coupled to a second coil movable relative to the first coil and rotatable about a rotation axis, with the steps of: feeding alternating current from the source to the first coil for generating a magnetic field; transmitting the magnetic field to the second coil, with the use of a magnetic field transmitter of magnetizable material for transmitting a magnetic field, which has a longitudinal axis, for inducing current in the second coil through the magnetic field, wherein the rotation axis of the second coil coincides with the longitudinal axis, wherein the magnetic field transmitter of magnetizable material extends through the first and second coils; transmitting the current induced in the second coil to the receiver.

The inventive apparatus for transmitting energy and/or information between a source and a receiver movable relative to the source includes a first coil coupled to the source, a second coil coupled to the receiver and movable relative to the first coil, and means for transmitting a magnetic field generated by the first coil to the second coil for inducing current in the second coil.

The present invention is based on the finding that alternating magnetic fields can be utilized for transmitting energy and/or information between two systems movable relative to each other. If the magnetic fields are generated by a stationary system, they can be transported to a vicinity of the movable system for example with the aid of a magnetizable core, whereby energy is transported toward the movable system, without the movable system having to be connected to the stationary system. If the (alternating) magnetic field generated by the stationary system penetrates a cross-sectional area of a coil arranged in the movable system, for example, currents are induced in the second coil, so that the receiver attached to the coil can be energized.

Here, the receiver may be a consumer having no energy source of its own but being energized by the magnetic field. Alternatively, the receiver may also have an energy source of its own, wherein the inventive concept may then be used to transmit only information between source and receiver as well as between receiver and source.

The inventive concept can be used to transmit information from the movable system toward the stationary system because an alteration of the consumption current, for example, by the system movable with respect to the stationary system results in a change in magnetic field energy to be delivered, wherein this change can be sensed by the stationary system.

By analogy, information can be transmitted from the stationary system toward the movable system. For example, if current flowing through the rigid coil is modulated, this results in a change in the magnetic field corresponding to the modulation, which can now be sensed by the movable receiver because the change in the magnetic field causes a corresponding change in the current induced in the second coil.

It is an advantage of the present invention that the movable consumer can be energized without requiring a battery for this. On the one hand, reliability of the energization is thereby increased, because no battery can fail. Thereby, it is also achieved that the movable consumer has less weight.

A further advantage of the present invention is to be seen in the fact that, along with the inventive energization structure, also a communication infrastructure is created, so that it can be done without additional transmit-receive structures, which leads to lowering the manufacturing and operation costs.

Another advantage of the present invention is to be seen in the fact that the energy transmission is realized via a change in the guided alternating magnetic fields. On the one hand, free-space radio waves are thereby avoided, which leads to reduction in interference probability within the systems. Moreover, a smaller amount of energy is now required altogether to transmit information, because the radio waves already mentioned do not have to be generated anymore. Since the transmission of information exclusively takes place via guided magnetic fields, the inventive concept may furthermore generally be employed where free-space propagation is not possible due to safety or health regulations, such as in hospitals, because pollution of the environment by alternating electromagnetic fields is lower.

A further advantage of the present invention is to be seen in the fact that the information can be transmitted without being bound to certain default frequencies, as this is the case with transponders, for example, so that the inventive concept can be employed in flexible manner.

The present invention can be employed for energy transmission and information transmission between two partners movable relative to each other. In this, one partner may be stationary and one partner moved. Alternatively, both partners may be moved differently, so that they are moved or movable relative to each other.

### BRIEF DESCRIPTION OF THE DRAWINGS

These and other objects and features of the present invention will become clear from the following description taken in conjunction with the accompanying drawings, in which:

FIG. 1 shows a first embodiment of an apparatus for transmitting energy according to the present invention;

FIG. 2 shows a further embodiment of an apparatus for transmitting energy according to the present invention;

FIG. 3 shows a further embodiment of an apparatus for transmitting energy according to the present invention.

### DESCRIPTION OF THE PREFERRED EMBODIMENTS

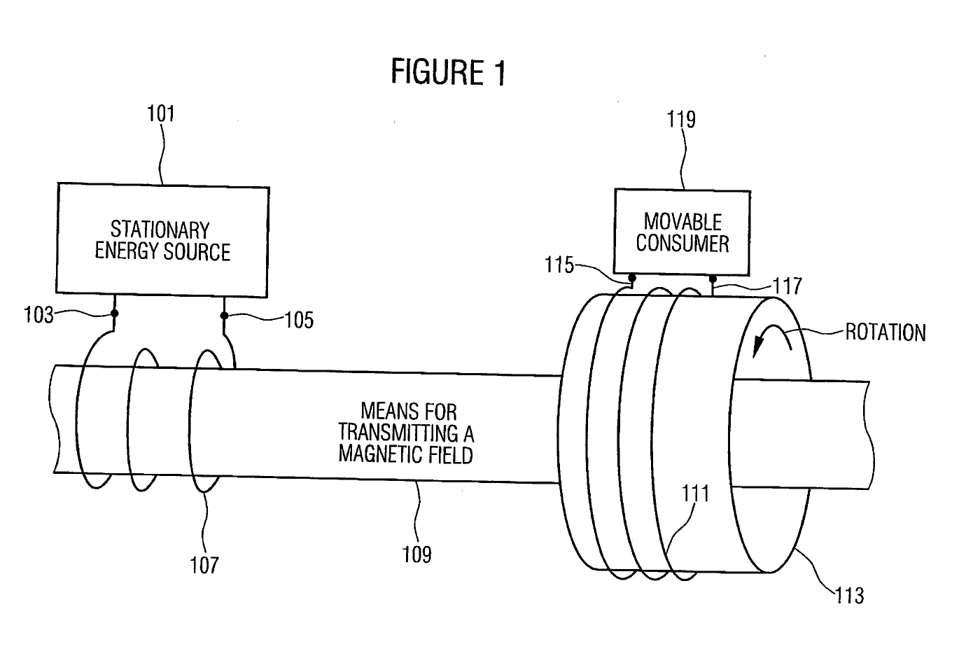

A first embodiment of an apparatus for transmitting energy between an energy source and a consumer movable relative to the energy source is illustrated in FIG. 1.

The apparatus includes an energy source 101 having a first terminal 103 and a second terminal 105. A first coil 107 is coupled to the terminals 103 and 105. Moreover, the apparatus illustrated in FIG. 1 comprises means 109 for transmitting a magnetic field, with means 109 having elongated expansion. This means that an axial expansion of means 109 is greater than a vertical one.

Means 109 for transmitting a magnetic field is arranged such that the windings of the first (stationary) coil are wound around part of means 109. In other words, means 109 for transmitting a magnetic field intersperses part of a coil cross-section of the first coil 107. Furthermore, a movable second coil 111 is wound around means 109 for transmitting a magnetic field, with the second coil 111 being spaced from the first coil 107. In the embodiment illustrated in FIG. 1, the second coil 111 is arranged on a rotating ring 113, which rotates, for example, according to the rotation direction drawn by the arrow illustrated in FIG. 1. The coil 111 comprises a first terminal 115 and a second terminal 117, wherein a movable consumer 119 is coupled to the terminals 115 and 117.

In the following, the functioning of the apparatus for transmitting energy illustrated in FIG. 1 will be explained.

In order to supply energy to the movable consumer 119, the first coil 107 is excited with an AC signal, for example, an alternating current or an alternating voltage, from the energy source 101 via the terminal 103 and 105, whereby an alternating electromagnetic field is generated. If means 109 for transmitting a magnetic field consists of magnetizable material, a magnetic flow characterizing the magnetic field develops in means 109 for transmitting a magnetic field. The magnetic field lines thus penetrate a coil cross-sectional area formed by the second coil 111, so that in the second coil 111, which rotates around means 109 for transmitting a magnetic field in the embodiment illustrated in FIG. 1, an alternating current, which may be fed to the movable consumer 119 via the terminals 115 and 117, is induced.

In the embodiment illustrated in FIG. 1, the movable consumer 119 rotates around means 109 for transmitting a magnetic field. At this point, however, it is to be pointed out that the movable consumer 119 may also move laterally, i.e. that the movable consumer 119 may also move along an axis of means 109 for transmitting a magnetic field. Moreover, the movable consumer 119 may move perpendicularly to the longitudinal axis of means 109. An arrangement of the movable consumer 119, as well as its movement, is only determined by an expansion of the magnetic field lines guided by means 109 for transmitting a magnetic field. This means that the second coil 111 is to be at least partially caught by the magnetic field lines so that current is induced, for example.

In the embodiment illustrated in FIG. 1, the movable consumer is arranged on the rotation ring 113 and thus rotates relative to the energy source 101 and relative to means 109 for transmitting a magnetic field. According to a further embodiment, means 109 for transmitting a magnetic field may itself be rotatable about a longitudinal axis and move relative to the energy source 101. If the windings of the first coil 107 are wound around means 109, wherein they are for example wound concentrically around the longitudinal axis, an alternating magnetic field required for energy transmission can still form in means 109. If the second coil 111 is arranged such that the magnetic field intersperses at least part of its cross-sectional area, a current feeding the movable consumer 119 is induced. The second coil 111 may rotate about the longitudinal axis, for example, at an angular velocity with which means 109 rotates. But it is also possible that the second coil 111 rotates about the longitudinal axis at an angular velocity differing from the angular velocity of means 109. The second coil 111 may also be fixedly connected to rotating means 109 for transmitting a magnetic field, so that a moved system consisting of means 109 as well as the coil 111 and the consumer 119 results, which moves relative to the stationary system consisting of the energy source 101 and the first coil 107.

The movable consumer 119 may for example be a sensor sensing a quantity indicating the rotation, such as angular velocity or angular acceleration. Here, if means 109 for transmitting a magnetic field is arranged around an axis, for example, and the movable consumer 119 rotates about the axis together with means 109 for transmitting a magnetic field, the movable consumer 119 may sense an angular velocity or also an angular acceleration of means 109 for transmitting a magnetic field, for example. If means 109 is an axle of a vehicle, for example, the movable consumer 119 may be arranged on the axle itself, or in a wheel connected to the axle, for example, in order to sense change in acceleration of the vehicle for example as an ABS (antiblocking system) sensor.

If the movable consumer 119 is embodied as a sensor, signals containing the sensed information have to be transmitted toward the stationary system. As already mentioned, this can be realized by alteration or by modulation of the energy taken up by the movable consumer 119.

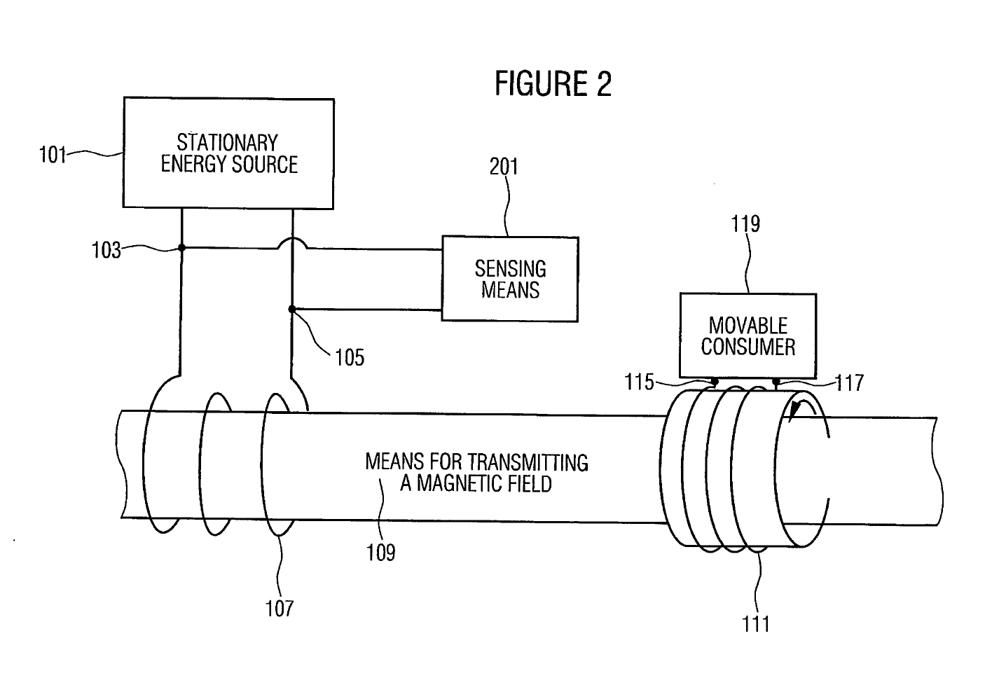

A further embodiment of an apparatus for transmitting energy between an energy source and a consumer movable relative to the energy source is illustrated in FIG. 2.

In contrast to the embodiment illustrated in FIG. 1, the apparatus illustrated in FIG. 2 includes sensing means 201 coupled between the terminals 103 and 105. The sensing means 201 is thus arranged in parallel to the energy source 101 and is thus also part of the stationary, i.e. the unmoved, system.

In the following, the embodiment illustrated in FIG. 2 will be explained in greater detail.

When the movable consumer 119 transmits information to the stationary system through a change in consumption energy, this leads to a change in the magnetic field formed in means 109, as already mentioned. The movable consumer 119 may for example modulate a consumption current such that an accompanying change in the amount of energy provided from the energy source can be sensed. Since the sensing means 201 is coupled to the first coil, it can be formed such that it senses a quantity indicative of the consumption energy taken up by the movable consumer 119. The sensing means 201 may for example be formed such that it senses current flowing through the first coil 107 or voltage present at the first coil 107 as the quantity indicative of the consumption energy. The sensing means 201 may for example be a current, voltage or power-measuring device with which the consumption energy is monitored.

In order to detect the information transmitted from the movable consumer 119, the sensing means 201 may further comprise detection means formed to detect the information transmitted from the movable consumer 119 from the quantity indicative of the consumption energy. Since the movable consumer 119 transmits the information about a change in the consumption energy, for example the consumption current, the detection means may for example be formed such that it determines the information transmitted from the movable consumer on the basis of a determination of a change in consumption energy within a predetermined time interval. The change in consumption energy may for example take place by averaging over the energy taken up within the predetermined time interval, with the predetermined time interval being chosen such that transients are not interpreted as transmitted information, which may for example be ensured if the predetermined time interval is greater than a millisecond.

The information supplied from the movable consumer 119 to the energy source 101, which is sensed by the sensing means 201, may take place, as already mentioned, through simple alteration of consumption energy, wherein a predetermined information unit, for example in form of a number, is associated with a predetermined value of consumption energy. It is also possible, however, that the movable consumer 119 encodes the information through alteration of the consumption energy within a time window, which is equal to the predetermined time interval, for example. In this case, a bit can be associated with the alteration of the consumption energy, so that the information to be transmitted can be encoded digitally.

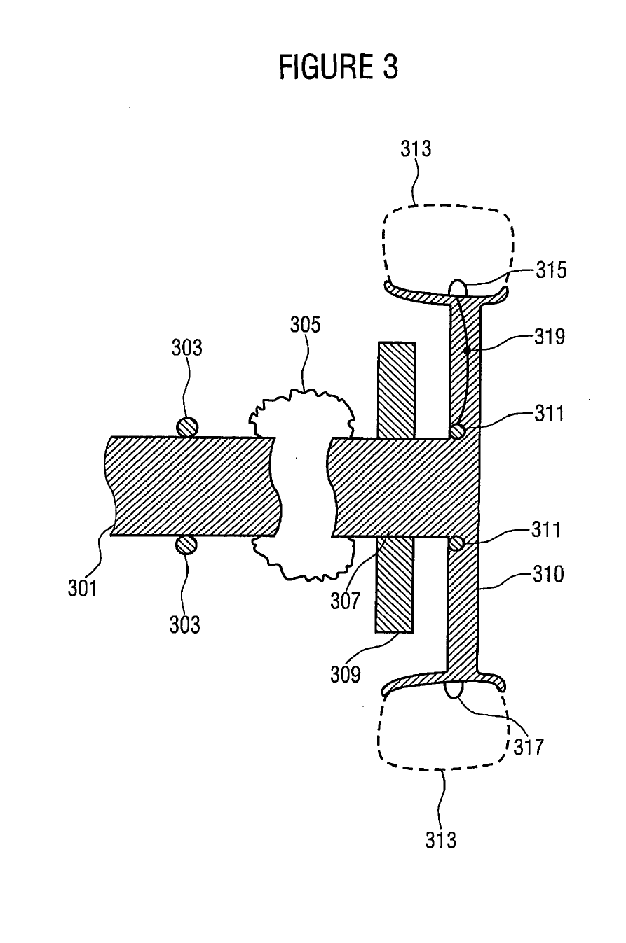

FIG. 3 shows a further embodiment of an inventive apparatus for transmitting energy between a stationary and a movable system in cross-sectional illustration, wherein the inventive concept is illustrated at an example of tire pressure measurement in a car tire.

The apparatus shown in FIG. 3 includes an axle 301. A rigid coil 303 is wound coaxially around the axle 301. A rotating shaft 307 (rotating part) is coupled to the axle 301 via a bearing 305, for example a ball bearing or a roller bearing. The rotating shaft 307 comprises a brake disk 309 connected thereto. Furthermore, a rim 310 is fixedly connected to the rotating shaft 307. Furthermore, a second coil 311 is arranged in the rim 310 such that a normal of the cross-sectional area formed by the coil windings is parallel to the longitudinal axis of the rotating shaft 307. A tire 313 is attached on the rim 310.

A movable consumer 315, which is a tire pressure sensor or, more specifically, a tire internal pressure sensor according to the embodiment illustrated in FIG. 3, is arranged on the rim and in the region in which the tire 313 is arranged. In order to balance a weight of the tire pressure sensor 315, a counterweight 317 is arranged on the opposite side of the rim. The tire pressure sensor 315 is connected to the rotating coil 311 via an electric connection 319.

In the following, the functioning of the embodiment illustrated in FIG. 3 will be explained.

In the embodiment illustrated in FIG. 3, the axle 301, the bearing 305, as well as the rotating part 307 preferably consist of magnetizable material and also form means for transmitting energy. If alternating current is fed to the coil 303 with the aid of an energy source not drawn in in FIG. 3, an alternating magnetic field, which can be transmitted toward the rotating coil 311 via the bearing 305, forms in the axle 301. Since the alternating current flowing through the rigid coil generates an alternating magnetic field guided through the axle, alternating voltage is induced in the rotating coil 311, because the alternating field intersperses part of the cross-sectional area formed by the windings of the rotating coil 311. Thereby, the tire pressure sensor 315 (measuring device) can be energized. At the same time, as already mentioned, information can be transmitted between the devices attached at the respective coil—a sensing means not drawn in in FIG. 3 and the tire pressure sensor 315—through modulation of the current through the rigid coil 303 or in the rotating coil 311. Via this information path, for example, a protocol defining, for example, instructions or measurement values from the rigid system to the rotating system or vice versa may be transmitted. In the rotating system, the protocol may for example be evaluated by means for processing not drawn in in FIG. 3, wherein means for processing may be accommodated in the wheel rim. By analogy, the information transmitted from the tire pressure sensor 315 toward the rigid system may be processed with the aid of further means for processing, which may for example be part of the detecting means not drawn in in FIG. 3.

As already mentioned, the tire pressure sensor 315 can transmit information to the stationary system through an alteration of the consumption current. Here, an alteration of the current induced in the rotating coil 311 causes a change in the current in the rigid coil 303. For evaluating the current alteration by the rigid coil, the sensing means already mentioned may comprise a reading device sensing the alteration of the current by the rigid coil and thus obtains the information about the measured internal tire pressure.

In connection with the embodiment illustrated in FIG. 3, the inventive method of transmitting energy and information between resting and rotating systems by means of alternating magnetic fields has been exemplarily considered at the example of transmission of a measurement result from an interior space of a pneumatic tire to a non-rotating part of a vehicle. At this point, however, it is to be pointed out that the inventive concept may be employed for energizing any movable consumers.

Moreover, the inventive concept is applicable in all cases where energy transmission between a rigid part and a rotating part or between parts moving with different velocities, as well as data transmission between the two parts, takes place.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. An apparatus for transmitting energy and information between a source and a receiver movable relative to the source, comprising:
a first coil coupled to the source;
a second coil coupled to the receiver and rotatable about a rotation axis relative to the first coil; and
a magnetic field transmitter of magnetizable material for transmitting a magnetic field generated by the first coil to the second coil for inducing a current in the second coil;
wherein the rotation axis of the rotatable second coil coincides with a longitudinal axis of the magnetic field transmitter, and
wherein the magnetic field transmitter of magnetizable material extends through the first and second coils.

2. The apparatus of claim 1, wherein the source is an energy source and wherein the receiver is a consumer.

3. The apparatus of claim 2, further comprising a sensor coupled to the first coil for sensing a quantity indicative of the consumption energy taken up by the consumer, wherein the consumer is formed to transmit information to the sensor by alteration of the consumption energy.

4. The apparatus of claim 3, wherein the sensor is formed to sense current flowing through the first coil or voltage present at the first coil as the quantity indicative of the consumption energy.

5. The apparatus of claim 3, wherein the sensor comprises a detector formed to detect the information transmitted from the consumer from the quantity indicative of the consumption energy.

6. The apparatus of claim 1, wherein the magnetic field transmitter is rotatable about a longitudinal axis, wherein the first coil is arranged around the longitudinal axis, wherein the second coil is rotatable about the longitudinal axis.

7. The apparatus of claim 1, wherein the magnetic field transmitter comprises an axle and a shaft rotatable about a longitudinal axis to which a wheel, at which the second coil is attached, is connected, wherein the wheel comprises a tire, and wherein the receiver is connected to the wheel and formed to measure an internal tire pressure.

8. The apparatus of claim 1, wherein the magnetic field transmitter is rotatable about an axis, and wherein the receiver rotates about the axis, wherein the receiver is formed to sense a quantity indicative of the rotation of the magnetic field transmitter.

9. The apparatus of claim 8, wherein the receiver is formed to measure angular velocity or angular acceleration as the quantity indicative of the rotation.

10. The apparatus of claim 1, further comprising a modulator for modulating alternating current fed to the first coil, in order to transmit information to the receiver.

11. A method of transmitting energy and information between a source coupled to a coil and a receiver movable relative to the source and coupled to a second coil movable relative to the first coil and rotatable about a rotation axis, comprising the steps of:
feeding alternating current from the source to the first coil for generating a magnetic field;
transmitting the magnetic field to the second coil, with the use of a magnetic field transmitter of magnetizable material for transmitting a magnetic field, which has a longitudinal axis, for inducing current in the second coil through the magnetic field, wherein the rotation axis of the second coil coincides with the longitudinal axis, wherein the magnetic field transmitter of magnetizable material extends through the first and second coils;
transmitting the current induced in the second coil to the receiver.

12. The method of claim 11, further comprising a step of modulating the alternating current for transmitting information to the receiver.

13. The method of claim 11, further for transmitting information from the receiver to the source, further comprising the steps of:
taking out energy from the current induced in the second coil corresponding to information to be transmitted; and
sensing a quantity indicative of the energy taken out for obtaining information at the first coil.

14. The method of claim 11, wherein the source is an energy source and wherein the receiver is a consumer.
